(19) United States
(12) Patent Application Publication
(10) Pub. No.: US 2009/0158345 A1
(43) Pub. Date: Jun. 18, 2009

(54) TELEVISION USER MODE

(76) Inventor: Peter Mortensen, Tustin, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/958,249

(22) Filed: Dec. 17, 2007

(51) Int. Cl. G06F 3/00

(52) U.S. Cl. 725/47

(57) ABSTRACT

Systems and methods for effectively hiding or disabling rarely used features and capabilities of a television so such features do not disturb the daily ease of use of the television and unauthorized users are prevented from changing settings and degrading the performance of the television. The television system preferably can be setup or programmed to work in either an “advanced mode” or a “daily use mode.” In the advanced mode, a user or installer is provided access to both all setup and all daily use functionality or features of the television. In the daily use mode, the overall user interface is optimized to avoid cluttering the menu system with features not needed for daily use. Users can operate all the features of the television necessary for daily use without altering any of the “authorized user only” settings and the less technically skilled will enjoy improved ease of use.

### FIELD

The present invention relates generally to televisions and, more particularly, to systems and methods that facilitate ease of use while hiding advance functions and settings.

### BACKGROUND

The capabilities and features of televisions continue to expand and improve. Many televisions include features and capabilities that allow a user or operator to fine tune picture and audio performance, device setup and the like in order to provide the highest quality presentation for a given viewing environment and content to be viewed. Although useful for certified CEDIA (Custom Electronic Design and Installation Association) installers, this expansion in capabilities and features has increased the operational complexity of televisions for ordinary users. As a result, ordinary users can find themselves unnecessarily searching through an array of rarely used features or selections to conduct basic operations of the television, or find themselves attempting to improve picture quality or simply experimenting with the televisions settings only to find they have significantly degraded the picture quality or the operation of the television in general. Other users including children may also inadvertently change settings that have been carefully setup and/or tweaked by the owner or installer

Therefore, it would be desirable to provide systems and methods that facilitate ease of daily use by hiding or disabling rarely used and/or advanced features.

### SUMMARY

Embodiments described herein are directed to improved methods and systems for effectively hiding or disabling rarely used features and capabilities of a television so such features do not disturb the daily ease of use of the television and unauthorized users are prevented from changing settings and degrading the performance of the television. As provided in the embodiments described herein, the television system can be setup or programmed to work in either an “advanced mode” or a “daily use mode.” In the advanced mode, a user or installer is provided access to both all setup and all daily use functionality or features of the television. The advanced mode is of particular relevance during the installation process done by a professional installer or a household member doing the installation of the television. In the advanced mode the user or operator can adjust, e.g., picture performance parameters, audio performance parameters, connections, connected device (e.g. names of devices), user preferences (e.g., menu language, v-chip settings, closed caption, etc.), and the like to optimize the performance of the television.

In daily operation, the advance settings or capabilities can significantly disturb operation of the television and enable unintentional degradation of its performance. Such drawbacks are overcome by switching or setting the television system to the “daily use mode,” which is preferably the default setting for the television after setup of the television. In the daily use mode, which can be activated through a simple user interface or the television's on screen menu system, the overall user interface is optimized to avoid cluttering the menu system with features not needed for daily use. Users can operate all the features of the television necessary for daily use without altering any of the “authorized user only” settings and the less technically skilled will enjoy improved ease of use.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television system.

FIG. 2 is a process diagram of a menu system for selecting different modes of operation.

FIG. 3 is a process diagram depicting a method for toggling to an advanced menu modes.

FIG. 4 is a process diagram depicting operation of the television system in different modes of operation.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments described herein are directed to improved methods and systems for effectively hiding or disabling rarely used features and capabilities of a television so such features do not disturb the daily ease of use of the television and unauthorized users are prevented from changing settings and degrading the performance of the television. As provided in the embodiments described herein, the television system can be setup or programmed to work in either an “advanced mode” or a “daily use mode.” In the advanced mode, a user or installer is provided access to both all setup and all daily use functionality or features of the television. The advanced mode is of particular relevance during the installation process done by a professional installer or a household member doing the installation of the television. In the advanced mode the user or operator can adjust, e.g., picture performance parameters, audio performance parameters, connections, connected device (e.g. names of devices), user preferences (e.g., menu language, v-chip settings, closed caption, etc.), and the like to optimize the performance of the television.

In daily operation, the advance settings or capabilities can significantly disturb operation of the television and enable unintentional degradation of its performance. Such drawbacks are overcome by switching or setting the television system to the “daily use mode,” which is preferably the default setting for the television after setup of the television. In the daily use mode, which can be activated through a simple user interface or the television's on screen menu system, the overall user interface is optimized to avoid cluttering the menu system with features not needed for daily use. Users can operate all the features of the television necessary for daily use without altering any of the “authorized user only” settings and the less technically skilled will enjoy improved ease of use.

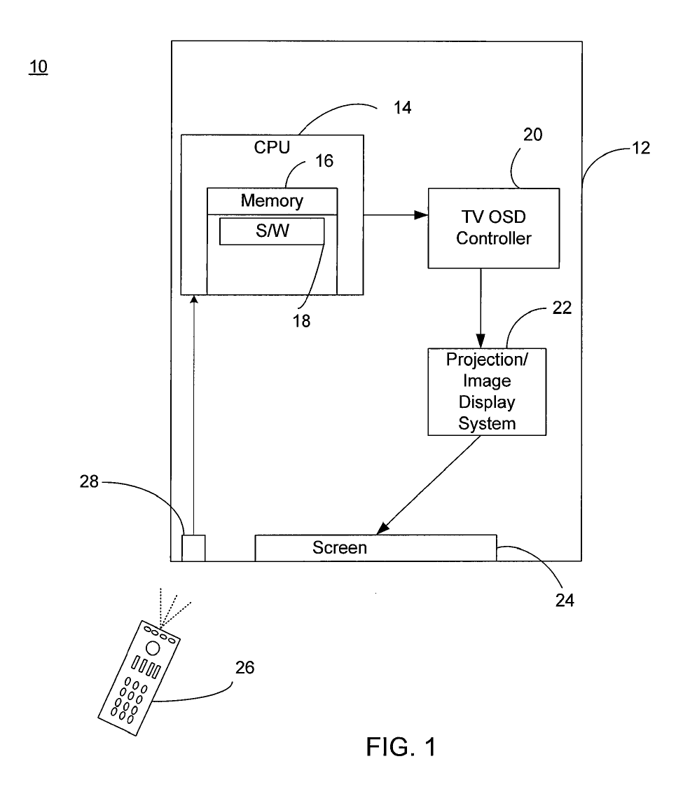

Turning to the figures, the embodiments provided herein are described in detail. A typical television 10, as depicted in FIG. 1, includes an enclosure 12 and a screen 24 housed in or coupled to the enclosure 12. Housed within the enclosure 12 is a central processing unit (CPU) 14 including non-volatile memory 16 with system software 18 stored therein. The software 18 preferably comprises a set of instructions to enable the setup and operation of the television system 10 in either of the modes of operation. Also housed within the enclosure 12 is an image display system 22, such as a projection system or the like, coupled to the screen 24 and an on screen display (OSD) controller 20 coupled to the CPU 14 and the image display system 22. The OSD 20 controls what is displayed on the screen 24.

The television system 10 preferably further includes a remote control device 26 wirelessly coupled to the television 10 to operate and control the television. The remote control device 26 can send infra red (IR) signals, radio frequency (RF) signals or like that are received by a receiver 28 housed in the enclosure 12 and coupled to the CPU 14. The televisions system 10 can also be controlled through the use of buttons positioned on a control panel (not shown) located on the front or adjacent the front of the enclosure 12 and coupled to the CPU 14.

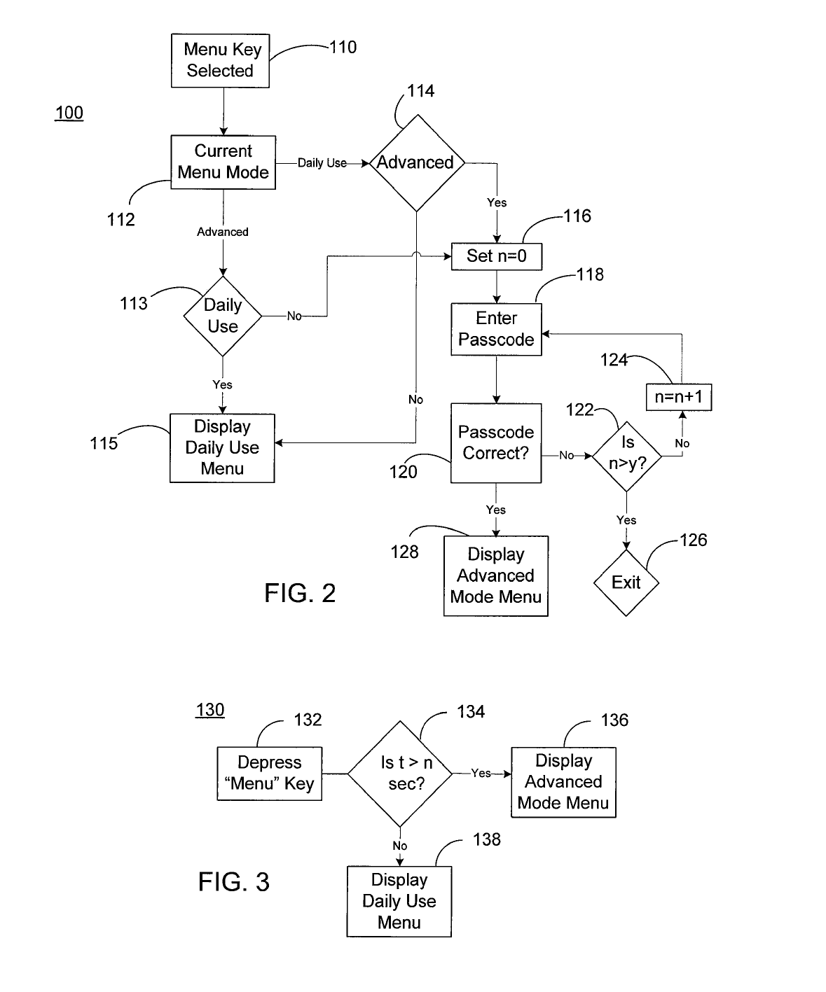

In operation, preferably advanced mode of operation can be activated by the user or installer. In one embodiment, the advanced mode can be activated through the television's menu system 100 as depicted in FIG. 2. As shown, when the user or installer selects or depresses a “menu” key at step 110, the system will determine at step 112 whether the current mode of operation is either a “daily use” or “advanced” mode of operation. If the system is in “daily use” mode, which is the default in a preferred embodiment, the user or installer is prompted at step 114 to indicate whether the “advanced” mode should be activated. If the user or installer indicates that the advanced mode should not be activated, the daily use menu will be displayed at step 115. If the user or installer selects the “advanced” mode, a counter, n, is set to zero at step 116. Preferably the counter is set to zero each time the television is powered on. The user or installer is then preferably prompted to enter a passcode at step 118. The passcode can be factory set and/or user definable. At step 120, the passcode is compared to a passcode stored in memory 16 (FIG. 1). If the entered passcode matches the stored passcode, the advanced mode menu is displayed at step 128. If the entered passcode is not a correct passcode, the system will check at step 122 to see if a counter n is greater than a predetermined amount y, e.g., five (5), and, if not, the counter n will be incremented by one (1) at step 177 prior to the operator being prompted at step 116 to re-enter a passcode. If the counter n is greater than y, the system will exit the menu system at step 126 and return to the viewing operation of the television 10.

Similarly, if the system is in “advanced” mode, the user or installer is prompted at step 113 to indicate whether the “daily use” mode should be activated. If the user or installer indicates the “advanced” mode should not be activated, the system sets the counter to zero at step 116 and prompts the user or installer for a passcode at step 118. If the daily use mode is selected at step 113, the daily use menu will be displayed at 115.

Alternatively, the desired mode of operation can be activated by using a single button on the remote control 26 or the front panel of the television 10 to toggle to the advanced mode as illustrated in the process 130 shown in FIG. 3. If at step 132 in FIG. 3 the user or installer depresses the “Menu” key on the remote control 26 or the front panel of the television 10 the system, at step 134, will determine whether the Menu key has been depressed for a period of time greater than a predetermined period of time (n seconds), e.g., five (5) seconds. If not, the system will display the daily use menu at step 138. If the Menu key has been depressed for a period of time t that is greater than n seconds, the system will toggle to the advanced mode of operation and display the advanced mode menu at step 136. This alternative method will eliminate unauthorized users from accidentally enabling the advanced mode of operation and still keep it easy for authorized users to re-enable advanced mode when needed.

If, however, additional security is desired, the operator could be prompted to enter a passcode or the remote control 26 could be equipped with a biometric reader to scan the thumb print of the operator to confirm the operator is authorized to change modes of operation.

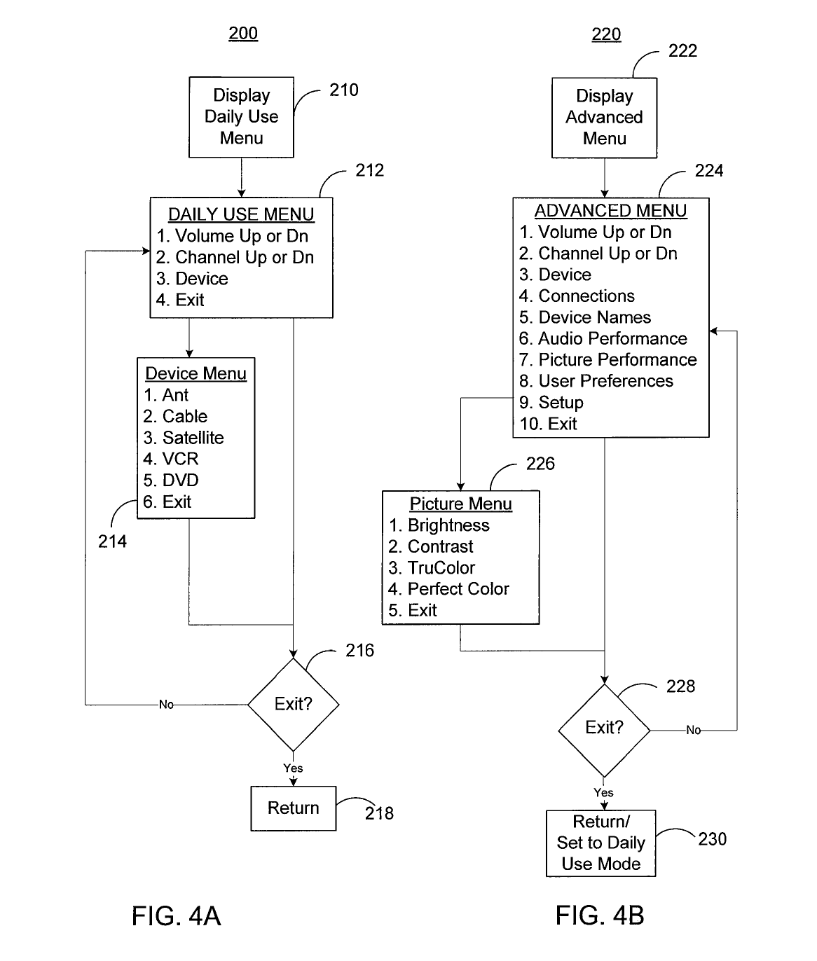

If the advance mode is not activated and the daily use menu is displayed at step 210 of process 200 shown in FIG. 4A, the operator or user will be presented at step 212 with a pared down menu and be prompted to select from such pared down set of options as, e.g., Volume up or down, Channel up or down, or Device selection. If the operator or user selects, e.g., Device, a Device menu will be displayed at step 214 prompting the operator or user to select an input device. Once the operator or user has made a selection, the system prompts the operator or user at step 216 as to whether they would like to exit the menu system and, if yes, the system at step 218 returns to the viewing operation of the television.

If the “advanced” mode is active, the system will display the advanced menu at step 222 of process 220 shown in FIG. 4B. At step 224, the operator or user will be presented with a expanded menu and be prompted to select from an expanded set of option such as, e.g., Volume up or down, Channel up or down, Device, Connections, Device Names, Audio Performance, Picture Performance, User Preferences, Set Up and the like. If the operator or user selects, e.g., Picture Performance, a Picture menu will be displayed at step 226 prompting the operator or user to select a feature to adjust. Once the operator or user has made a selection and finished the adjustment, the system will prompt the operator or user at step 228 as to whether they would like to exit the menu system and, if yes, the system at step 230 returns to the viewing operation of the television.

In order to prevent unauthorized access to advanced or “authorized user only” features, the system can include a “time out” feature that will automatically toggle the system from the “advance” mode to the “daily use” mode after a predetermined amount of time. Preferably, the system is automatically toggled from the “advance” mode to the “daily use” mode after power or AC off or at power or AC on.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A control system for a television comprising
a screen,
a projection/image display system coupled to the screen,
an on-screen-display (OSD) controller coupled to the display system and the screen,
a video input coupled to the OSD, and
a central processing unit (CPU) coupled to the OSD controller, the CPU comprising non-volatile memory upon which a software program is stored, the software program includes a set of instructions for toggling between advanced and non-advanced modes of operation.

2. The control system of claim 1 wherein the software program further comprises a second set of instructions for displaying a menu comprising a greater number of menu options than a second menu that is displaying when the system is in the non-advanced mode of operation.

3. A method for controlling a television comprising
receiving an indication that a predetermined control key has been depressed, and
displaying an advanced menu if the predetermined control key has been depressed for a period of time greater than a predetermined period of time and a non-advanced menu if the predetermined control key has been depressed for a period of time less than the predetermined period of time, wherein the advanced menu comprising a greater number of selection options than the non-advanced menu.

4. The method of claim 3 further comprising the step of prompting a user for the input of a pass-code if the predetermined control key has been depressed for a period of time greater than the predetermined period of time.

5. The method of claim 3 further comprising the step of prompting a user to present a biometric feature of the user for scanning if the predetermined control key has been depressed for a period of time greater than the predetermined period of time.

6. The method of claim 5 wherein the biometric feature is a thumb print.

7. A method for controlling a television comprising
receiving an indication that a predetermined control key has been depressed, and
toggling from a non-advanced mode of operation to an advanced mode of operation if the predetermined control key has been depressed for a period of time greater than a predetermined period of time, wherein a menu displayable in the advance mode of operation has a greater number of menu selection options than a menu displayable in the non-advanced mode of operation.

8. The method of claim 7 further comprising the step of prompting a user for the input of a pass-code if the predetermined control key has been depressed for a period of time greater than the predetermined period of time.

9. The method of claim 7 further comprising the step of prompting a user to present a biometric feature of the user for scanning if the predetermined control key has been depressed for a period of time greater than the predetermined period of time.

10. The method of claim 8 wherein the biometric feature is a thumb print.

11. The method of claim 7 further comprising the step of toggling from the advanced mode of operation to the non-advanced of operation after a second predetermined period of time.

12. A method for controlling a television comprising
receiving an indication that a predetermined control key has been depressed,
determining if current mode of operation is advanced or non-advanced, and
prompting a user to toggle from advanced mode of operation to non-advanced mode or operation or from non-advanced mode of operation to advanced mode of operation depending on the current mode of operation.

13. The method of claim 12 further comprising the step of prompting a user for the input of a pass-code when in advanced mode of operation.

14. The method of claim 13 further comprising the step of comparing an entered passcode to a passcode store in memory.

15. The method of claim 14 further comprising the step of displaying an advanced mode menu if the entered passcode matches the stored passcode, wherein the advanced mode menu comprising a greater number of selection options than provided in a non-advanced mode menu.

16. The method of claim 12 further comprising the step of prompting a user to present a biometric feature when in advanced mode of operation.

17. The method of claim 16 wherein the biometric feature is a thumb print.
